(19) United States
(12) Patent Application Publication
(10) Pub. No.: US 2014/0213358 A1
(43) Pub. Date: Jul. 31, 2014

(54) GAMING PLATFORM PROVIDING A MULTI-MOVE GAME OPERATION

(71) Applicant: Zynga Inc., San Francisco, CA (US)

(72) Inventor: Michael McCarthy, Oakland, CA (US)

(73) Assignee: Zynga Inc., San Francisco, CA (US)

(21) Appl. No.: 14/165,025

(22) Filed: Jan. 27, 2014

Related U.S. Application Data
(60) Provisional application No. 61/758,559, filed on Jan. 30, 2013.

(51) Int. Cl. A63F 13/00

(52) U.S. Cl. CPC A63F 13/00
USPC 463/31

(57) ABSTRACT

A system, computer-readable storage medium, and a method for providing a multi-move game operation are presented. A virtual game environment that includes a first game object and a second game object is generated where the first game object includes a location associated with a first location and the second game object includes a location associated with a second location within the virtual game environment. Responsive to detecting a user selection of the first game object, the system may enable a move state for the first game object. Then, responsive to detecting a placement selection, the system may update the location of the first game object from the first location to the destination location and disable the move state for the first game object. Responsive to determining that the destination location is proximate to the second location, the system may enable a move state for the second game object.

### CROSS REFERENCE TO RELATED APPLICATIONS

This application claims priority from U.S. Provisional Appl. No. 61/758,559, filed Jan. 30, 2013, entitled “GAME PLATFORM PROVIDING A MULTI-MOVE GAME OPERATION,” all of which is incorporated herein by reference in its entirety for all purpose.

### TECHNICAL FIELD

The present disclosure relates to gaming platforms. In particular, an example gaming platform is provided to perform user initiated game operations.

### BACKGROUND

In conventional game systems, a user may interact with a game by using a user input device to select and move individual game objects displayed in a virtual environment. For example, in a virtual farming game, a user may move a first game object (e.g., a virtual animal) by using a mouse device to position a game pointer proximate to the first game object and then pressing a button on the mouse device (e.g., the left mouse button) to initiate the move operation. Once the move operation is initiated, the player may specify a destination location for the first game object by moving the game pointer to another position within the virtual game environment and then pressing the button on the mouse device again to complete the move operation. Upon detecting that the move operation has been completed, the game system may update various data structures to specify that the game object is associated with the destination location.

To move a second game object, the player may repeat the operations of positioning the game pointer proximate to the second game object, pressing the button on the mouse device, specifying the destination location for the second game object, and pressing the button on the mouse device again.

Thus, in conventional system, game objects are moved within a virtual environment by repeating the sequence of selecting a game object and selecting a game object for each game object being moved in the virtual environment.

### BRIEF DESCRIPTION OF THE DRAWINGS

The present disclosure is illustrated by way of example, and not limitation, in the figures of the accompanying drawings, in which like reference numerals indicate similar elements unless otherwise indicated. In the drawings,

FIG. 1 illustrates an example of a gaming environment for implementing various example embodiments;

FIG. 2 illustrates an example of a social network within a social graph, according to some embodiments;

FIG. 3 is a block diagram depicting various modules, in accordance with example embodiments, that may be included in a processing system;

FIG. 4 is a flow chart illustrating a method of performing a multi-move game operation, according to an example embodiment;

FIGS. 5A-E are diagrams showing a sequence of screenshots illustrating a multi-move game operation, according to example embodiments;

FIG. 6 illustrates an example data flow between example components of the example system of FIG. 1, according to some embodiments;

FIG. 7 illustrates an example network environment, in which various example embodiments may operate; and

FIG. 8 illustrates an example computing system architecture, which may be used to implement one or more of the methodologies described herein, according to some embodiments.

### DESCRIPTION OF EXAMPLE EMBODIMENTS

### Overview

Users of computer-implemented systems may access a gaming platform to interact with a virtual environment. For example, through a gaming platform, as provided by Zynga, Inc., a user (e.g., a player) may access a virtual game that depicts a virtual game environment with a multitude of game objects located therein. By way of example and not limitation, the virtual game may display a virtual farming environment with a multitude of virtual crops, avatars, virtual animals, virtual buildings, and the like. Each of the game objects (e.g., the virtual crops, the avatars, the virtual animals, the virtual buildings) of the virtual game environment may be “movable” within the virtual game environment. As used herein, the term “movable” may refer to a property of a game object that allows a player to specify a location within the virtual game environment where the game object is to be placed. As used herein, the term “move operation” may refer to a game operation performed by a component of a gaming environment platform that associates or otherwise assigns a game object with a player specified location within the virtual game environment.

To illustrate a move operation, a virtual animal may be initially associated with a first location within the virtual game environment, such as a location within play pen. Accordingly, when the gaming environment platform generates the virtual game environment, the virtual animal may be displayed within the play pen. Later, the player may decide that virtual animal should be moved to a location within a feeding field. To move the virtual animal to the location within the feeding field, the player may initiate a move operation to associate the virtual animal with the location within the feeding field. Accordingly, the gaming platform may cause the virtual game environment to update the virtual game environment so that the virtual animal is displayed at the location within the feeding field. Where a move operation only involves moving one game object from one location to another location, such a move operation may be referred to as a single move operation.

Consistent with example embodiments described herein, a gaming platform may monitor user interactions involving the virtual game environment to perform a multi-move operation on two or more game objects. As used herein, a “multi-move operation” may be a game operation performed by the gaming platform to move multiple game objects. To illustrate, an example embodiment may support a multi-move operation that combines a placement of one game object with the selection of another game object.

To perform a multi-move operation, the gaming platform, in an example embodiment, may initiate a first move operation on a first game object. The first move operation may be initiated by the gaming platform in response to detecting a user selection of the first game object. For example, the gaming platform may detect that a user has used a mouse to click on the first game object. Clicking on the first game object may initiate the move operation on the first game object.

After the gaming platform initiates the move operation on the first game object, the gaming platform, in some embodiments, may detect a placement selection. A “placement selection,” as used herein, may refer to a user input that specifies that the selected game object is to be placed at a specified position within the virtual game environment. An example of a placement selection is when, after initiating a movement operation, the player clicks on a mouse button, taps on a touch-screen, or any other suitable user interface interaction while the mouse cursor is located over a location within the virtual game environment. Responsive to detecting the placement selection, the gaming platform may then associate the first game object with a location corresponding to the placement selection.

Further, consistent with example embodiments, the gaming platform may detect that the location associated with the placement selection is associated with the placement of a second game object. Accordingly, example embodiments may initiate a second move operation in response to the detected second game object.

It is to be appreciated that a gaming platform providing a multi-move game operation may find many practical applications. For example, a virtual farming game may use the multi-move game operation to provide a comparatively convenient technique for placing two or more game objects in the virtual farm. Such may be the case when user actions involved in placing a location and selecting another object are combined. Eliminating repetitive user actions may improve a user's enjoyment in a game. Further, eliminating repetitive user actions may reduce the risk of fatigue and physical injury, such as carpel tunnel syndrome. Consequently, some embodiments may provide numerous advantages that improves user experience and, in turn, increases player engagements with a gaming system.

These and other embodiments of the invention are described, by way of example, in further detail below.

### Example System

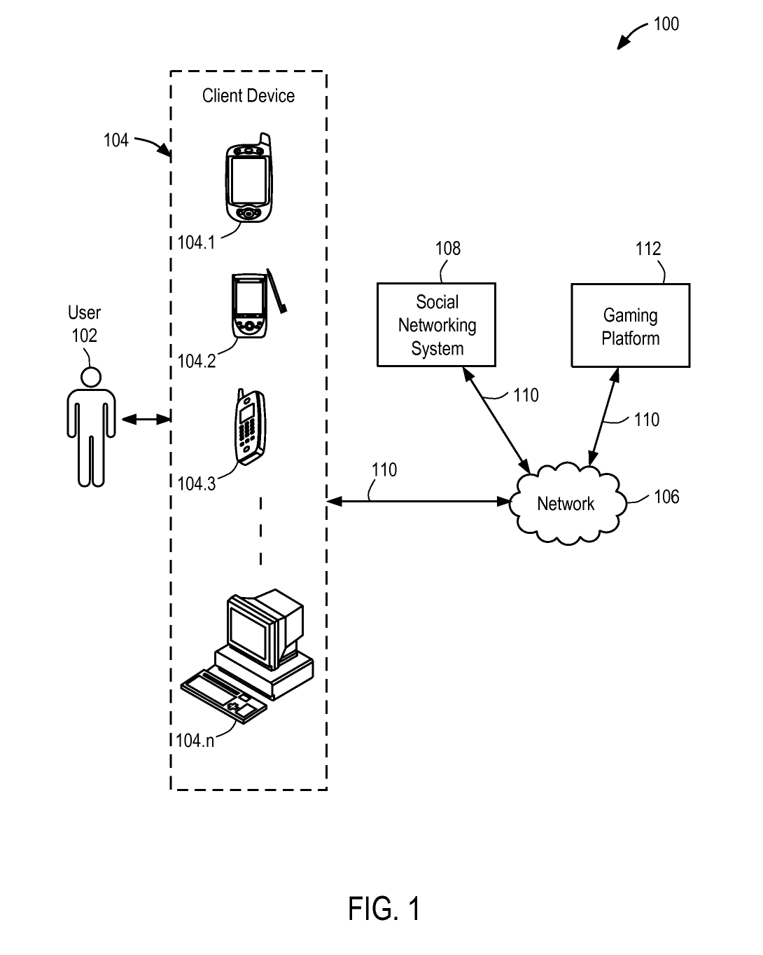

FIG. 1 illustrates an example of a gaming environment 100 for implementing various example embodiments. In some embodiments, the gaming environment 100 comprises a user 102, a client device 104, a network 106, a social networking system 108, and a gaming platform 112. The components of the gaming environment 100 may be connected directly or over a network 106, which may be any suitable network. In various embodiments, one or more portions of the network 106 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or any other type of network, or a combination of two or more such networks.

Although FIG. 1 illustrates a particular example of the arrangement of the user 102, the client device 104, the social networking system 108, the gaming platform 112, and the network 106, any suitable arrangement or configuration of the user 102, the client device 104, the social networking system 108, the gaming platform 112, and the network 106 may be contemplated.

The client device 104 may be any suitable computing device (e.g., devices 104.1-104.n), such as a smart phone 104.1, a personal digital assistant 104.2, a mobile phone 104.3, a personal computer 104.n, a laptop, a computing tablet, or any other device suitable for playing a virtual game. The client device 104 may access the social networking system 108 or the gaming platform 112 directly, via the network 106, or via a third-party system. For example, the client device 104 may access the gaming platform 112 via the social networking system 108.

In some embodiments, the client device 104 may be communicatively coupled to or include an input device, such as a keyboard, a pointing device, and a display device (not shown). Such input devices may allow a user to interact with a game provided by the gaming platform 112. For example, with the input devices, the client device 104 may allow a user to select (e.g., through a mouse click or a finger tap on a touch screen) a game object. Selecting a game object may cause the gaming platform 112 to perform a game action on the selected game object.

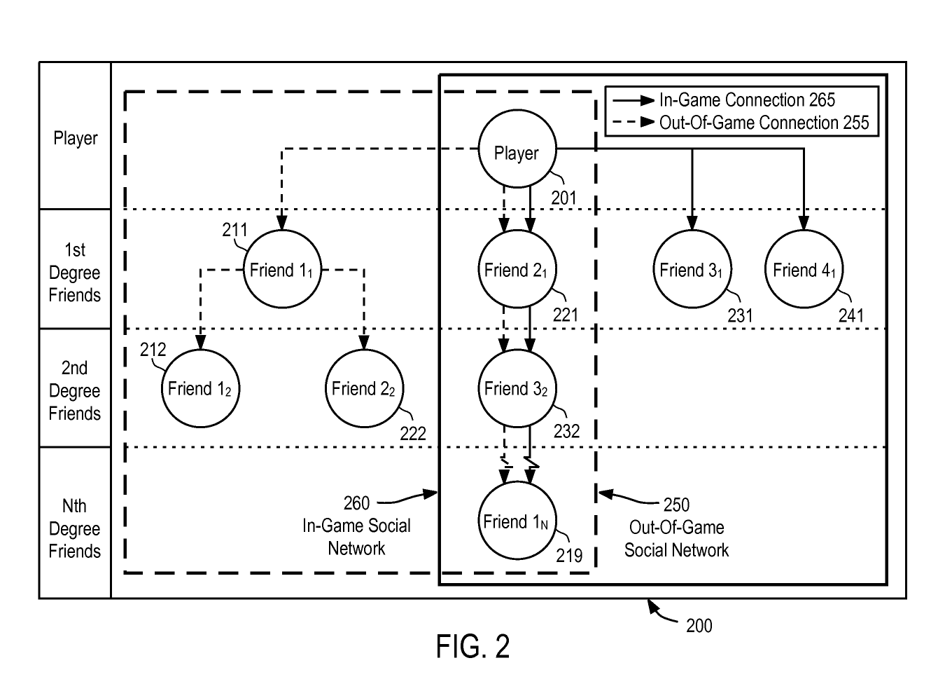

The social networking system 108 may include a network-addressable computing system that can host one or more social graphs (see for example FIG. 2), and may be accessed by the other components of system 100 either directly or via the network 106. The social networking system 108 may generate, store, receive, and transmit social networking data.

FIG. 2 shows an example of a social network within a social graph 200. The social graph 200 is shown by way of example to include an out-of-game social network 250 and an in-game social network 260. Moreover, the in-game social network 260 may include one or more users that are friends with Player 201 (e.g., Friend 3₁ 231), and may include one or more other users that are not friends with Player 201. The social graph 200 may correspond to the various users associated with the virtual game. In an example embodiment, each user may “build” their own virtual structures using branded game objects and/or unbranded game objects. A “branded game object” may refer to a game object that may be customizable with a logo, image, text, or any other customizable feature. When, for example, Player 201 visits the virtual environment of Friend 3₁ 231, the virtual environment displayed to Player 201 includes banded objects selected and placed in that environment by Friend 3₁ 231.

With reference back to FIG. 1, the gaming platform 112 may include a network-addressable computing system (or systems) that can host one or more virtual games, for example, online games. The gaming platform 112 may generate, store, receive, and transmit game-related data, such as, for example, game account data, game input, game state data, and game displays. The gaming platform 112 may be accessed by the other components of the gaming environment 100 either directly or via the network 106. The user 102 may use the client device 104 to access, send data to, and receive data from the social networking system 108 and/or the gaming platform 112.

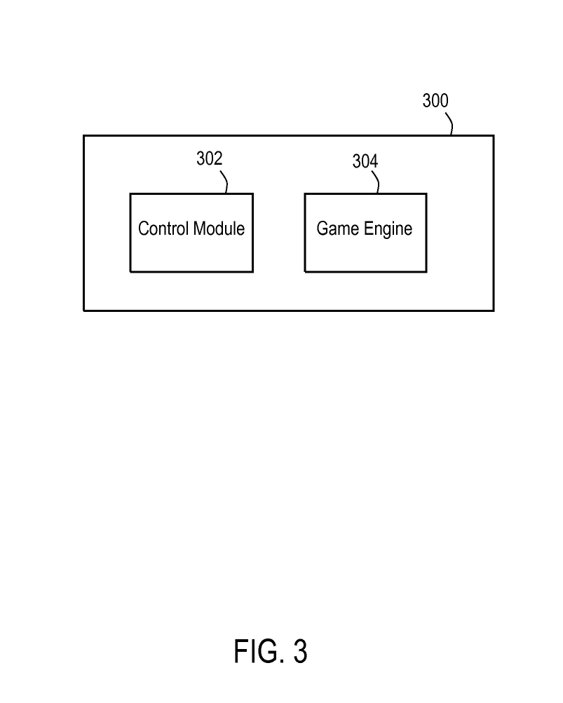

FIG. 3 is a block diagram depicting various modules, in accordance with example embodiments, that may be included in a processing system 300. It should be appreciated that the processing system 300 may be deployed in the form of, for example, a server computer, a client computer, a personal computer, a laptop computer, a mobile phone, a personal digital assistant, and other processing systems. For example, in one embodiment, the processing system 300 may be embodied as the gaming platform 112 of the gaming environment 100 depicted in FIG. 1. In an alternate embodiment, the processing system 300 may be embodied as the client device 104 of the gaming environment 100. As a further example, the processing system 300 may be embodied as a combination of the gaming platform 112 and the client device 104 of the gaming environment 100 depicted in FIG. 1. Referring to FIG. 3, in various embodiments, the processing system 300 may be used to implement computer programs, logic, applications, methods, processes, or software to provide a multi-move game operation, as is described in more detail below.

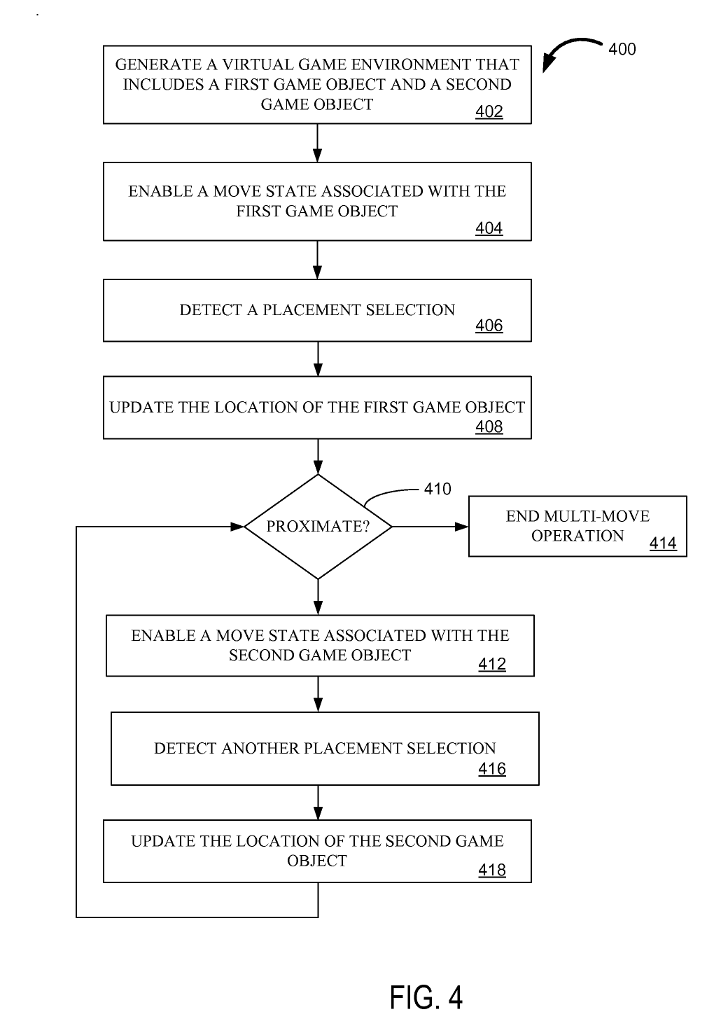

As FIG. 3 shows, the processing system 300 may include a control module 302 and a game engine 304. The control module 302 may be configured to translate user input into game actions that are to be performed by the game engine 304. For example, consistent with embodiments described in this disclosure, the control module 302 may receive user input data that signals that a particular game object or virtual game environment location has been selected. Responsive to receiving the user input data, the control module 302 may cause the game engine to perform a particular game action on the selected game object. Further, the control module 302 may detect whether the user has initiated a multi-move game operation that allows the player to combine a placement selection with a user selection of a game object. The multi-move game operation is described in greater detail below with reference to FIGS. 4-6.

The game engine module 304, according to various embodiments, may be configured to perform operations related to generating, storing, receiving, and transmitting game-related data, such as, for example, game account data, game input, game state data, and game displays. In example embodiments, the game engine module 304 may perform the operations related to generating, storing, receiving, and transmitting game-related data responsive to receiving game actions from the control module 302.

It should be appreciated that in other embodiments, the processing system 300 may include fewer, more, or different modules apart from those shown in FIG. 3. For example, in an alternate embodiment, control module 302 and the game engine module 302 may be combined into one module. In another embodiment, the control module 302 can be separate from and executed or processed in parallel with the game engine module 302.

FIG. 4 is a flow chart illustrating a method 400 of performing a multi-move game operation, according to an example embodiment. In an embodiment, the method 400 may be implemented by the components and modules shown in FIGS. 1 and 3, and, as a result, will be described with reference thereto.

As depicted in FIG. 4, the method 400 may begin at operation 402 when the method 400 (e.g., game engine 304) generates a virtual game environment that includes a first game object and a second game object. By way of example and not limitation, generating the virtual game environment may involve causing the virtual game environment to be displayed on the client device 104. In an example embodiment, the game engine 304 can generate the virtual game environment by sending game data representing the state of the virtual game environment to the client device 104. The virtual game environment, in some embodiments, may depict a landscape, building, city, game board, or any other environment. In turn, the first and second game objects may depict moveable game elements within the virtual game environment, such as crops, buildings, characters, letters, game board pieces, or any other suitable game element. As a game object may have a position within the virtual game board, the game object may have a corresponding property that specifies a location. Such a property may be a field that specifies an absolute position (as may be specified in a coordinate system) or a relative position (as may be specified by a measurement relative to another game object). In some embodiments, a “property” is a member or field of a data structure that stores a value that characterizes an aspect of a game object, such as the game object's location.

At operation 404, in response to detecting a user selection of the first game object, the method 400 may enable a move state associated with the first game object. For example, in some embodiments, the control module 302 may detect that a user has selected a virtual animal by clicking a mouse button while the cursor was over or substantially proximate to the virtual animal. Upon detecting the user selection of the virtual animal, the game engine 304 may then update a property associated with the virtual animal to indicate that the virtual animal is in a move state. While the virtual animal is in a move state, the game engine may cause the virtual animal to be displayed at a location associated with the game cursor such that the location of the virtual animal substantially mirrors the location of the game cursor. At least conceptually, in some embodiments, operation 404 may initiate a multi-move operation.

At operation 406, the control module 302 may detect a placement selection initiated by the user as part of the move operation. As described above, a placement selection may be a user initiated operation that signals a destination for a game object being moved. For example, a player may use the mouse to move a game cursor to a given location and then click or release a mouse button to generate a placement selection for the given location. In other embodiments, a player may use the mouse to hover a game cursor over a given location to generate a placement selection for the given location (e.g., the destination). The control module 302 may determine that a game cursor is hovering over the given location (e.g., the destination) by tracking an amount of time the game cursor has been located proximate to the given location and then comparing the amount of time to a hover time threshold, where, for example, if the amount of time is greater than the hover time threshold, control module 302 may determine that a placement selection has been made. In yet other embodiments, a placement selection may be detected when a player releases a mouse button or performs a finger gesture on a touch screen (e.g., taps a touch screen or releases a finger from the touch screen).

At operation 408, the game engine 304 may update the location of the first game object from the initial location to the destination location associated with the placement selection. In some embodiments, operation 408 is performed by updating a location property associated with the location of the first game object to indicate that the current location of the first game object is the location associated with the placement selection (e.g., the destination). In some cases, the location property may be part of a data structure associated with the first game object or, in other cases, a data structure associated with the virtual game environment. Operation 408 may, in some embodiments, involve the game engine 304 disabling a move state associated with the first game object. When the first game object is moved out of the move state, the game engine 304 may stop depicting the first game object at a location proximate to the game cursor.

At decision 410, the game engine 304 may determine whether the location associated with the placement selection (e.g., the destination location) is proximate to the second location. One location may be proximate to another location when the distance between the two locations is within a distance threshold. Additionally or alternatively, a location associated with a game object may be proximate to the location of another game object when any portion of the two game objects overlap with each other.

Based on the destination location being located proximate to the second location, the method 400 may then continue the multi-move game operation at operation 412. Otherwise, the method 400 ends the multi-move operation at operation 414.

At operation 412, the method 400 continues when the control module 302 enables a move state associated with the second game object by, for example, updating a record or data structure associated with the second game object to indicate that the second game object is in a move state. Also, when the second game object is in the move state, the game engine 304 may depict the game object at a location proximate to the game cursor. Again, when the move state for a game object is enabled, a user may select a destination location within the virtual game environment in which to place the game object.

It is to be appreciated that the move state for the second game object may be enabled without the player re-activating (clicking on the mouse button or tapping a touch screen a second time) the selection input. In this way, some embodiments may provide a comparatively efficient mechanism for a player to perform a type of game action on multiple game objects within a virtual game because a user interface operation for placing one game object is combine with a user interface operation for initiating a move operation with another game object. Such efficiencies may improve a user experience and, in turn, may increase player interactions with a game hosted in a gaming environment.

At operation 416, the control module 302 may detect another placement selection initiated by the user as part of the same move operation initiated at operation 404. The placement selection detected at operation 416 may specify another destination location. For example, the user may select a destination within the game environment to place the second game object.

At operation 418, the game engine 304 may update the location of the second game object from the initial location of the second game object to the destination location of the placement selection detected at operation 416. In some embodiments, operation 418 is performed by updating a location property associated with the location of the second game object to indicate that the current location of the second game object is the location associated with the placement selection (e.g., the destination). In some cases, the location property may be part of a data structure associated with the first second game object or, in other cases, a data structure associated with the virtual game environment.

It is to be appreciated that the method may loop back to the decision 410 so that the control module 302 may determine whether the destination location for the other placement selection is proximate to another (e.g., a third) game object. If yes, the method may perform operations 412, 416, and 418 over again with respect to the third game object. Otherwise, the method 400 may end at operation 414.

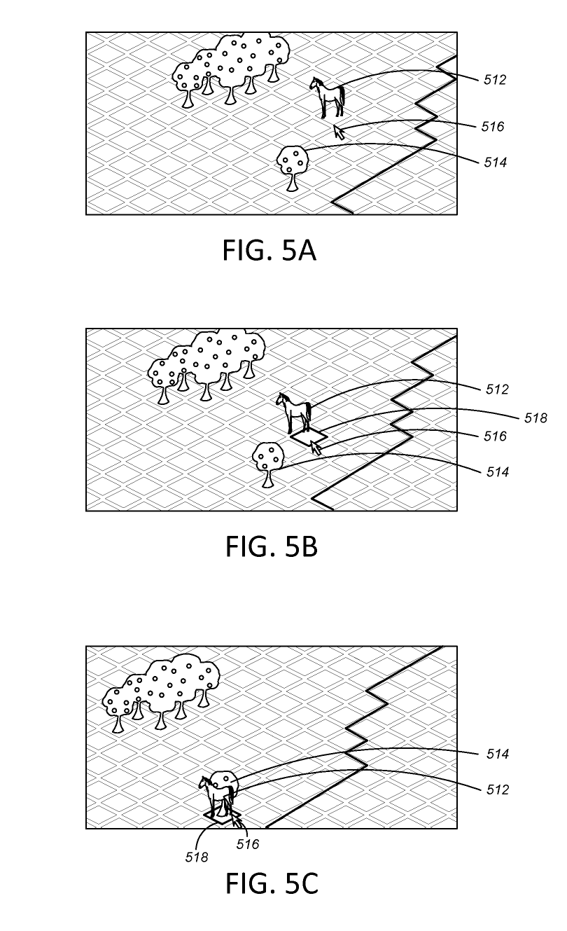

FIGS. 5A-E are diagrams showing a sequence of screenshots illustrating a multi-move game operation, according to example embodiments. It is to be appreciated that each of the FIGS. 5A-E represent a state of a virtual game environment at different points in time. For example, FIG. 5A may represent the state of the virtual game environment at a first point in time, FIG. 5B may represent the state of the virtual game environment at a second point in time, FIG. 5C may represent the state of the virtual game environment at a third point in time, FIG. 5D may represent the state of the virtual game environment at a fourth point in time, and FIG. 5E may represent the state of the virtual game environment at a fifth point in time.

The operation of a multi-move operation is now described in greater detail. FIG. 5A shows a screenshot 502 of a virtual game environment that includes various game objects, such as a virtual animal 512 and virtual crop 514. As described above, each of the game objects may be associated with a record that maintains the state of the game object. For example, the record associated with the virtual animal 512 may have a field that specifies the current location for the virtual animal 512. The virtual crop 514 may also have a field that specifies the current location for the virtual crop 514. Further, also described above, each of the game objects 512, 514 may be moveable by the player.

FIG. 5A also shows that the screenshot 502 includes a game cursor 516. As described above, the game cursor may refer to any suitable user input element that identifies a location within the virtual game environment. Although FIG. 5A depicts the game cursor 516 as a mouse pointer, it is to be appreciated that other game cursors may be utilized by embodiments contemplated by this disclosure. For example, in other embodiments, the game cursor may correspond to finger gestures (e.g., tapping, sliding, or swiping), for example, on a touch screen.

FIG. 5B is a screenshot 504 depicting the state of the virtual game environment at a later point in time, relative to the screenshot 502. In screenshot 504, a user has used the game cursor 516 to select the virtual animal 512. Accordingly, the game engine 304 has initiated a move operation for the virtual animal 512. While the move operation is initiated for the virtual animal 512, the game engine 304 may highlight a placement location 518 corresponding to the game cursor. The placement location may correspond to a location within the virtual game environment where the virtual animal 512 is to be placed if the player initiates a placement selection.

FIG. 5C is a screenshot 506 depicting the state of the virtual game environment at a later point in time, relative to the screenshot 504. In screenshot 506, a user has positioned the game cursor 516 to a location proximate to the virtual crop 514. In some embodiments, the control module 302 may cause the game engine 304 to update the placement location 518 with an indication that, upon a detection of the placement selection, the control module 302 may cause the game engine 304 to associate the virtual animal with a location currently associated with a second game object (e.g., the virtual crop 516) and then initiated move operation on the second game object. Such an indication may be different than other indications that merely indicate that a game object may be placed at the current location or indications that merely indicate that a game object cannot validly be placed at the current location.

When the game cursor 516 is position approximate to the virtual crop 514, the player may then initiate a placement selection by performing a mouse click, tapping a touch screen, or hovering the game cursor 516 over the virtual crop for a time that exceeds a hover time threshold. Upon detecting the placement selection initiated by the user, the control module 302 may cause the game engine 304 to update the location of the virtual animal 512 to be the location associated with the placement selection.

In addition to placing the virtual animal 512, the control module 302 may initiate a move state relative to the virtual crop 514. The control module 302 may initiate the move operation based on the location associated with the placement operation being proximate to the location of the virtual crop 514.

After a move state has been activated relative to the virtual crop 514, the control module 302 may cause the game engine 304 to highlight the location correspond to the game cursor 516 to provide an indication of where the virtual crop 514 will be placed if the player initiates a placement operation. This indication is shown in FIG. 5D. FIG. 5D is a screenshot 508 depicting the state of the virtual game environment at a later point in time, relative to the screenshot 506. In screenshot 508, the player has moved the game cursor to a location indicated by the placement location 520. Relative to FIG. 5D, the player may move the virtual crop 514 to a location for placement.

FIG. 5E is a screenshot 510 depicting the state of the virtual game environment at a later point in time, relative to the screenshot 508. For example, FIG. 5E may correspond to a point in time where a player has made a placement selection for the virtual crop after initiated a movement operation on the virtual crop, as was described with reference to FIGS. 5C and 5D.

It is to be appreciated that the second move operation occurs without the player re-activating (clicking on the mouse button or tapping a touch screen a second time) the selection input. In this way, some embodiments may provide a comparatively efficient mechanism for a player to perform a type of game action on multiple game objects within a virtual game because a user interface operation for placing one game object is combine with a user interface operation for initiating a move operation with another game object. Such efficiencies may improve a user experience and, in turn, may increase player interactions with a game hosted in a gaming environment.

Thus, it is to be appreciated through the above discussion, some embodiments may use a multi-move operation to move two or more game objects without the player re-activating (clicking on the mouse button or tapping a touch screen a second time) the selection input. In this way, some embodiments may provide a comparatively efficient mechanism for a player to perform a type of game action on multiple game objects within a virtual game because a user interface operation for placing one game object is combine with a user interface operation for initiating a move operation with another game object. As discussed above, such efficiencies may improve a user experience and, in turn, may increase player interactions with a game hosted in a gaming environment.

### Example Game Systems, Social Networks, and Social Graphs

As described above, the systems described herein may include, communicate, or otherwise interact with a game system. As such, the game system is now described to illustrate further embodiments. In an online multiuser game, users control player characters (PCs), a game engine controls non-player characters (NPCs), and the game engine also manages player character state and tracks states for currently active (e.g., online) users and currently inactive (e.g., offline) users.

A player character may have a set of attributes and a set of friends associated with the player character. As used herein, the terms “state” and “attribute” can be used interchangeably to refer to any in-game characteristic of a player character, such as location, assets, levels, condition, health, status, inventory, skill set, name, orientation, affiliation, specialty, and so on. The game engine may use a player character state to determine the outcome of a game event, sometimes also considering set variables or random variables. Generally, an outcome is more favorable to a current player character (or player characters) when the player character has a better state. For example, a healthier player character is less likely to die in a particular encounter relative to a weaker player character or non-player character.

A game event may be an outcome of an engagement, a provision of access, rights and/or benefits or the obtaining of some assets (e.g., health, money, strength, inventory, land, etc.). A game engine may determine the outcome of a game event according to game rules (e.g., “a character with less than 5 health points will be prevented from initiating an attack”), based on a character's state and possibly also interactions of other player characters and a random calculation. Moreover, an engagement may include simple tasks (e.g., cross the river, shoot at an opponent), complex tasks (e.g., win a battle, unlock a puzzle, build a factory, rob a liquor store), or other events.

In a game system according to aspects of the present disclosure, in determining the outcome of a game event in a game being played by a user (or a group of more than one users), the game engine may take into account the state of the player character (or group of player characters (PCs)) that is playing, but also the state of one or more PCs of offline/inactive users who are connected to the current user (or PC, or group of PCs) through the game social graph but are not necessarily involved in the game at the time.

For example, User A with six friends on User A's team (e.g., the friends that are listed as being in the user's mob/gang/set/army/business/crew/etc. depending on the nature of the game) may be playing the virtual game and choose to confront User B who has 20 friends on User B's team. In some embodiments, a user may only have first-degree friends on the user's team. In other embodiments, a user may also have second-degree and higher degree friends on the user's team. To resolve the game event, in some embodiments the game engine may total up the weapon strength of the seven members of User A's team and the weapon strength of the 21 members of User B's team and decide an outcome of the confrontation based on a random variable applied to a probability distribution that favors the side with the greater total. In some embodiments, all of this may be done without any other current active participants other than User A (e.g., User A's friends, User, B, and User B's friends could all be offline or inactive). In some embodiments, the friends in a user's team may see a change in their state as part of the outcome of the game event. In some embodiments, the state (e.g., assets, condition, level) of friends beyond the first degree are taken into account.

Example Gaming Platforms

A virtual game may be hosted by the gaming platform 112, which can be accessed using any suitable connection 110 with a suitable client device 104. A user may have a game account on the gaming platform 112, wherein the game account may contain a variety of information associated with the user (e.g., the user's personal information, financial information, purchase history, player character state, game state, etc.). In some embodiments, a user may play multiple games on the gaming platform 112, which may maintain a single game account for the user with respect to the multiple games, or multiple individual game accounts for each game with respect to the user. In some embodiments, the gaming platform 112 may assign a unique identifier to a user 102 of a virtual game hosted on the gaming platform 112. The gaming platform 112 may determine that the user 102 is accessing the virtual game by reading the user's cookies, which may be appended to HTTP requests transmitted by the client device 104, and/or by the user 102 logging onto the virtual game.

In some embodiments, the user 102 accesses a virtual game and control the game's progress via the client device 104 (e.g., by inputting commands to the game at the client device 104). The client device 104 can display the game interface, receive inputs from the user 102, transmit user inputs or other events to the game engine, and receive instructions from the game engine. The game engine can be executed on any suitable system (such as, for example, the client device 104, the social networking system 108, or the gaming platform 112). For example, the client device 104 may download client components of a virtual game, which are executed locally, while a remote game server, such as the gaming platform 112, provides backend support for the client components and may be responsible for maintaining application data of the game, processing the inputs from the user 102, updating and/or synchronizing the game state based on the game logic and each input from the user 102, and transmitting instructions to the client device 104. As another example, when the user 102 provides an input to the game through the client device 104 (such as, for example, by typing on the keyboard or clicking the mouse of the client device 104), the client components of the game may transmit the user's input to the gaming platform 112.

In some embodiments, the user 102 accesses particular game instances of a virtual game. A game instance is a copy of a specific game play area that is created during runtime. In some embodiments, a game instance is a discrete game play area where one or more users 102 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables.

In some embodiments, a specific game instance may be associated with one or more specific users. A game instance is associated with a specific user when one or more game parameters of the game instance are associated with the specific user. For example, a game instance associated with a first user may be named “First User's Play Area.” This game instance may be populated with the first user's PC and one or more in-game objects associated with the first user.

In some embodiments, a game instance associated with a specific user is only accessible by that specific user. For example, a first user may access a first game instance when playing a virtual game, and this first game instance may be inaccessible to all other users. In other embodiments, a game instance associated with a specific user is accessible by one or more other users, either synchronously or asynchronously with the specific user's game play. For example, a first user may be associated with a first game instance, but the first game instance may be accessed by all first-degree friends in the first user's social network.

In some embodiments, the set of in-game actions available to a specific user is different in a game instance that is associated with this user compared to a game instance that is not associated with this user. The set of in-game actions available to a specific user in a game instance associated with this user may be a subset, superset, or independent of the set of in-game actions available to this user in a game instance that is not associated with him. For example, a first user may be associated with Blackacre Farm in an online farming game, and may be able to plant crops on Blackacre Farm. If the first user accesses a game instance associated with another user, such as Whiteacre Farm, the game engine may not allow the first user to plant crops in that game instance. However, other in-game actions may be available to the first user, such as watering or fertilizing crops on Whiteacre Farm.

In some embodiments, a game engine interfaces with a social graph. Social graphs are models of connections between entities (e.g., individuals, users, contacts, friends, users, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In some embodiments, a unique client identifier may be assigned to individual users in the social graph. This disclosure assumes that at least one entity of a social graph is a user or player character in an online multiuser game.

In some embodiments, the social graph is managed by the gaming platform 112, which is managed by the game operator. In other embodiments, the social graph is part of a social networking system 108 managed by a third party (e.g., Facebook, Friendster, Myspace). In yet other embodiments, the user 102 has a social network on both the gaming platform 112 and the social networking system 108, wherein the user 102 can have a social network on the gaming platform 112 that is a subset, superset, or independent of the user's social network on the social networking system 108. In such combined systems, game network system 112 can maintain social graph information with edge-type attributes that indicate whether a given friend is an “in-game friend,” an “out-of-game friend,” or both. The various embodiments disclosed herein are operable when the social graph is managed by the social networking system 108, the gaming platform 112, or both.

### Example Systems and Methods

Returning to FIG. 2, the User 201 may be associated, connected or linked to various other users, or “friends,” within the out-of-game social network 250. These associations, connections or links can track relationships between users within the out-of-game social network 250 and are commonly referred to as online “friends” or “friendships” between users. Each friend or friendship in a particular user's social network within a social graph is commonly referred to as a “node.” For purposes of illustration, the details of out-of-game social network 250 are described in relation to User 201. As used herein, the terms “user” and “player” can be used interchangeably and can refer to any user in an online multiuser game system or social networking system. As used herein, the term “friend” can mean any node within a user's social network.

As shown in FIG. 2, Player 201 has direct connections with several friends. When Player 201 has a direct connection with another individual, that connection is referred to as a first-degree friend. In out-of-game social network 250, Player 201 has two first-degree friends. That is, Player 201 is directly connected to Friend 1₁ 211 and Friend 2₁ 221. In the social graph 200, it is possible for individuals to be connected to other individuals through their first-degree friends (e.g., friends of friends). As described above, the number of edges in a minimum path that connects a user to another user is considered the degree of separation. For example, FIG. 2 shows that Player 201 has three second-degree friends to which Player 201 is connected via Player 201's connection to Player 201's first-degree friends. Second-degree Friend 1₂ 212 and Friend 2₂ 222 are connected to Player 201 via Player 201's first-degree Friend 1₁ 211. The limit on the depth of friend connections, or the number of degrees of separation for associations, that Player 201 is allowed is typically dictated by the restrictions and policies implemented by the social networking system 108.

In various embodiments, Player 201 can have Nth-degree friends connected to him through a chain of intermediary degree friends as indicated in FIG. 2. For example, Nth-degree Friend 1_{N} 219 is connected to Player 201 within in-game social network 260 via second-degree Friend 3₂ 232 and one or more other higher-degree friends.

In some embodiments, a user (or player character) has a social graph within an online multiuser game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in Player 201's out-of-game social network 250. Player 201 also has in-game connections 265 to a plurality of users, forming in-game social network 260. Here, Friend 2₁ 221, Friend 3₁ 231, and Friend 4₁ 241 are first-degree friends with Player 201 in Player 201's in-game social network 260. In some embodiments, a game engine can access in-game social network 260, out-of-game social network 250, or both.

In some embodiments, the connections in a user's in-game social network is formed both explicitly (e.g., when users “friend” each other) and implicitly (e.g., when the system observes user behaviors and “friends” users to each other). Unless otherwise indicated, reference to a friend connection between two or more users can be interpreted to cover both explicit and implicit connections, using one or more social graphs and other factors to infer friend connections. The friend connections can be unidirectional or bidirectional. It is also not a limitation of this description that two users who are deemed “friends” for the purposes of this disclosure are not friends in real life (e.g., in disintermediated interactions or the like), but that can be the case.

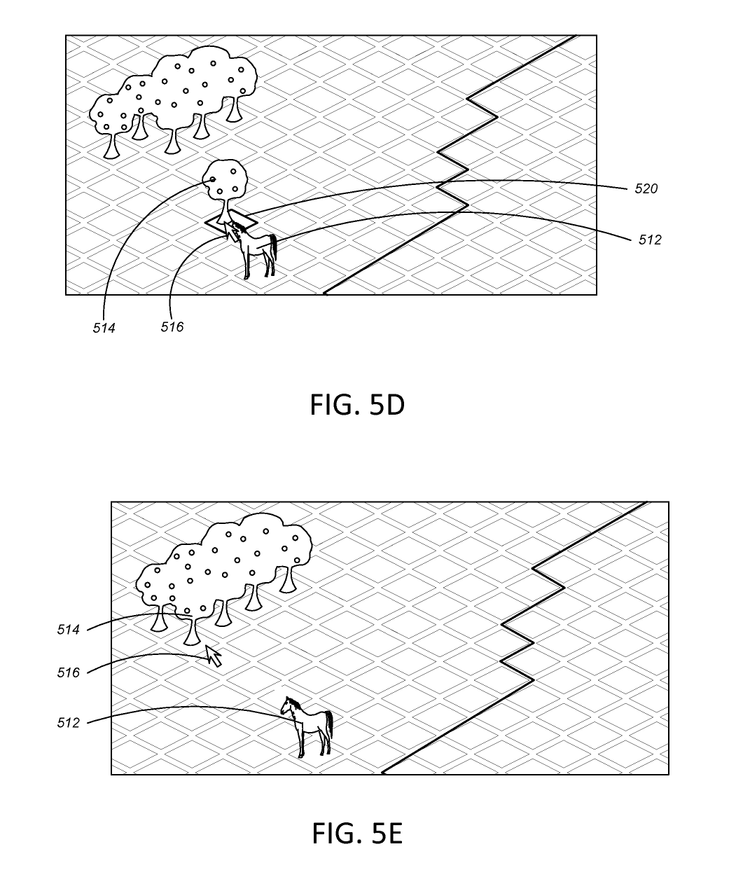

FIG. 6 illustrates an example data flow between example components of an example system 600. One or more of the components of the example system 600 may correspond to one or more of the components of the example gaming environment 100. In some embodiments, the system 600 includes a client system 630, a social networking system 620a, and a gaming platform 620b. The components of system 600 can be connected to each other in any suitable configuration, using any suitable type of connection. The components may be connected directly or over any suitable network. The client system 630, the social networking system 620a, and the gaming platform 620b may have one or more corresponding data stores such as local data store 625, social data store 645, and game data store 665, respectively.

The client system 630 may receive and transmit data 623 to and from the gaming platform 620b. This data can include, for example, a web page, a message, a game input, a game display, a HTTP packet, a data request, transaction information, and other suitable data. At some other time, or at the same time, the gaming platform 620b may communicate data 643, 647 (e.g., game state information, game system account information, page info, messages, data requests, updates) with other networking systems, such as the social networking system 620a (e.g., Facebook, Myspace). The client system 630 can also receive and transmit data 627 to and from the social networking system 620a. This data can include, for example, web pages, messages, social graph information, social network displays, HTTP packets, data requests, transaction information, updates, and other suitable data.

Communication between the client system 630, the social networking system 620a, and the gaming platform 620b can occur over any appropriate electronic communication medium or network using any suitable communications protocols. For example, the client system 630, as well as various servers of the systems described herein, may include Transport Control Protocol/Internet Protocol (TCP/IP) networking stacks to provide for datagram and transport functions. Of course, any other suitable network and transport layer protocols can be utilized.

In some embodiments, an instance of a virtual game is stored as a set of game state parameters that characterize the state of various in-game objects, such as, for example, player character state parameters, non-player character parameters, and virtual item parameters. In some embodiments, game state is maintained in a database as a serialized, unstructured string of text data as a so-called Binary Large Object (BLOB). When a user accesses a virtual game on the gaming platform 620b, the BLOB containing the game state for the instance corresponding to the user may be transmitted to the client system 630 for use by a client-side executed object to process. In some embodiments, the client-side executable is a FLASH-based game, which can de-serialize the game state data in the BLOB. As a user plays the game, the game logic implemented at the client system 630 maintains and modifies the various game state parameters locally. The client-side game logic may also batch game events, such as mouse clicks, and transmit these events to the gaming platform 620b. Gaming platform 620b may itself operate by retrieving a copy of the BLOB from a database or an intermediate memory cache (memcache) layer. The gaming platform 620b can also de-serialize the BLOB to resolve the game state parameters and execute its own game logic based on the events in the batch file of events transmitted by the client to synchronize the game state on the server side. The gaming platform 620b may then re-serialize the game state, now modified into a BLOB, and pass this to a memory cache layer for lazy updates to a persistent database.

In some embodiments, a computer-implemented game is a text-based or turn-based game implemented as a series of web pages that are generated after a user selects one or more actions to perform. The web pages may be displayed in a browser client executed on the client system 630. For example, a client application downloaded to the client system 630 may operate to serve a set of web pages to a user. As another example, a virtual game may be an animated or rendered game executable as a stand-alone application or within the context of a webpage or other structured document. In some embodiments, the virtual game is implemented using Adobe Flash-based technologies. As an example, a game may be fully or partially implemented as a SWF object that is embedded in a web page and executable by a Flash media user plug-in. In some embodiments, one or more described web pages is associated with or accessed by the social networking system 620a. This disclosure contemplates using any suitable application for the retrieval and rendering of structured documents hosted by any suitable network-addressable resource or website.

Application event data of a game is any data relevant to the game (e.g., user inputs). In some embodiments, each application datum may have a name and a value, and the value of the application datum may change (e.g., be updated) at any time. When an update to an application datum occurs at the client system 630, either caused by an action of a game user or by the game logic itself, the client system 630 may need to inform the gaming platform 620b of the update. For example, if the game is a farming game with a harvest mechanic (such as Zynga FarmVille), an event can correspond to a user clicking on a parcel of land to harvest a crop. In such an instance, the application event data may identify an event or action (e.g., harvest) and an object in the game to which the event or action applies.

In some embodiments, one or more objects of a game is represented as an Adobe Flash object. Flash may manipulate vector and raster graphics, and supports bidirectional streaming of audio and video. “Flash” may mean the authoring environment, the user, or the application files. In some embodiments, the client system 630 may include a Flash client. The Flash client may be configured to receive and run Flash application or game object code from any suitable networking system (such as, for example, the social networking system 620a or the gaming platform 620b). In some embodiments, the Flash client is run in a browser client executed on the client system 630. A user can interact with Flash objects using the client system 630 and the Flash client. The Flash objects can represent a variety of in-game objects. Thus, the user may perform various in-game actions on various in-game objects by making various changes and updates to the associated Flash objects.

In some embodiments, in-game actions are initiated by clicking or similarly interacting with a Flash object that represents a particular in-game object. For example, a user can interact with a Flash object to use, move, rotate, delete, attack, shoot, or harvest an in-game object. This disclosure contemplates performing any suitable in-game action by interacting with any suitable Flash object. In some embodiments, when the user makes a change to a Flash object representing an in-game object, the client-executed game logic may update one or more game state parameters associated with the in-game object. To ensure synchronization between the Flash object shown to the user at the client system 630, the Flash client may send the events that caused the game state changes to the in-game object to the gaming platform 620b. However, to expedite the processing and hence the speed of the overall gaming experience, the Flash client may collect a batch of some number of events or updates into a batch file. The number of events or updates may be determined by the Flash client dynamically or determined by the gaming platform 620b based on server loads or other factors. For example, client system 630 may send a batch file to the gaming platform 620b whenever 50 updates have been collected or after a threshold period of time, such as every minute.

As used herein, the term “application event data” may refer to any data relevant to a computer-implemented virtual game application that may affect one or more game state parameters, including, for example and without limitation, changes to user data or metadata, changes to user social connections or contacts, user inputs to the game, and events generated by the game logic. In some embodiments, each application datum has a name and a value. The value of an application datum may change at any time in response to the game play of a user or in response to the game engine (e.g., based on the game logic). In some embodiments, an application data update occurs when the value of a specific application datum is changed.

In some embodiments, when a user plays a virtual game on the client system 630, the gaming platform 620b serializes all the game-related data, including, for example and without limitation, game states, game events, user inputs, for this particular user and this particular game into a BLOB and may store the BLOB in a database. The BLOB may be associated with an identifier that indicates that the BLOB contains the serialized game-related data for a particular user and a particular virtual game. In some embodiments, while a user is not playing the virtual game, the corresponding BLOB may be stored in the database. This enables a user to stop playing the game at any time without losing the current state of the game the user is in. When a user resumes playing the game next time, gaming platform 620b may retrieve the corresponding BLOB from the database to determine the most-recent values of the game-related data. In some embodiments, while a user is playing the virtual game, the gaming platform 620b also loads the corresponding BLOB into a memory cache so that the game system may have faster access to the BLOB and the game-related data contained therein.

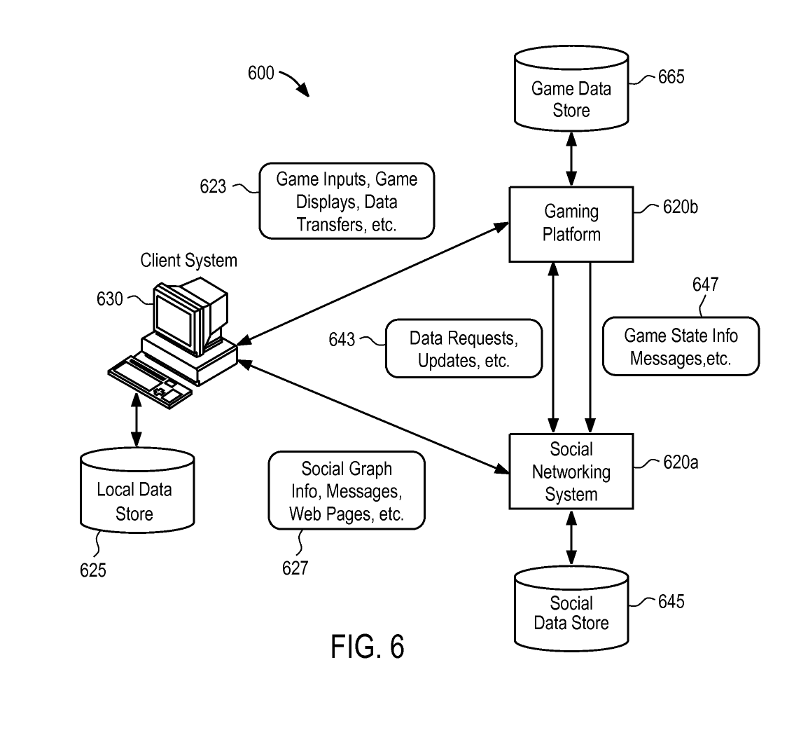

Various embodiments may operate in a wide area network environment, such as the Internet, including multiple network addressable systems. FIG. 7 illustrates an example network environment 700, in which various example embodiments may operate. Network cloud 760 generally represents one or more interconnected networks, over which the systems and hosts described herein can communicate. The network cloud 760 may include packet-based wide area networks (such as the Internet), private networks, wireless networks, satellite networks, cellular networks, paging networks, and the like. As FIG. 7 illustrates, various embodiments may operate in a network environment 700 comprising one or more networking systems, such as a social networking system 720a, a gaming platform 720b, and one or more client systems 730. The components of the social networking system 720a and the gaming platform 720b operate analogously; as such, hereinafter they may be referred to simply as the networking system 720. The client systems 730 are operably connected to the network environment 700 via a network service provider, a wireless carrier, or any other suitable means.

The networking system 720 is a network addressable system that, in various example embodiments, comprises one or more physical servers 722 and data stores 724. The one or more physical servers 722 are operably connected to the computer network cloud 760 via, by way of example, a set of routers and/or networking switches 726. In an example embodiment, the functionality hosted by the one or more physical servers 722 may include web or HTTP servers, FTP servers, as well as, without limitation, webpages and applications implemented using Common Gateway Interface (CGI) script, PHP Hyper-text Preprocessor (PHP), Active Server Pages (ASP), Hyper-Text Markup Language (HTML), Extensible Markup Language (XML), Java, JavaScript, Asynchronous JavaScript and XML (AJAX), Flash, ActionScript, and the like.

The physical servers 722 may host functionality directed to the operations of the networking system 720. Hereinafter, the servers 722 may be referred to as server 722, although the server 722 may include numerous servers hosting, for example, the networking system 720, as well as other content distribution servers, data stores, and databases. The data store 724 may store content and data relating to, and enabling, operation of, the networking system 720 as digital data objects. A data object, in some embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof. Content object data may also include executable code objects (e.g., games executable within a browser window or frame), podcasts, etc.

Logically, the data store 724 corresponds to one or more of a variety of separate and integrated databases, such as relational databases and object-oriented databases that maintain information as an integrated collection of logically related records or files stored on one or more physical systems. Structurally, the data store 724 may generally include one or more of a large class of data storage and management systems. In some embodiments, the data store 724 may be implemented by any suitable physical system(s) including components, such as one or more database servers, mass storage media, media library systems, storage area networks, data storage clouds, and the like. In one example embodiment, the data store 724 includes one or more servers, databases (e.g., MySQL), and/or data warehouses. Data store 724 may include data associated with different networking system 720 users and/or client systems 730.

The client system 730 is generally a computer or computing device including functionality for communicating (e.g., remotely) over a computer network. The client system 730 may be a desktop computer, laptop computer, personal digital assistant (PDA), in- or out-of-car navigation system, smart phone or other cellular or mobile phone, or mobile gaming device, among other suitable computing devices. The client system 730 may execute one or more client applications, such as a Web browser.

When a user at the client system 730 desires to view a particular webpage (hereinafter also referred to as target structured document) hosted by the networking system 720, the user's web browser, or other document rendering engine or suitable client application, formulates and transmits a request to the networking system 720. The request generally includes a URL or other document identifier as well as metadata or other information. By way of example, the request may include information identifying the user, a timestamp identifying when the request was transmitted, and/or location information identifying a geographic location of the user's client system 730 or a logical network location of the user's client system 730.

Although the example network environment 700 described above and illustrated in FIG. 7 is described with respect to the social networking system 720a and the gaming platform 720b, this disclosure encompasses any suitable network environment using any suitable systems. For example, a network environment may include online media systems, online reviewing systems, online search engines, online advertising systems, or any combination of two or more such systems.

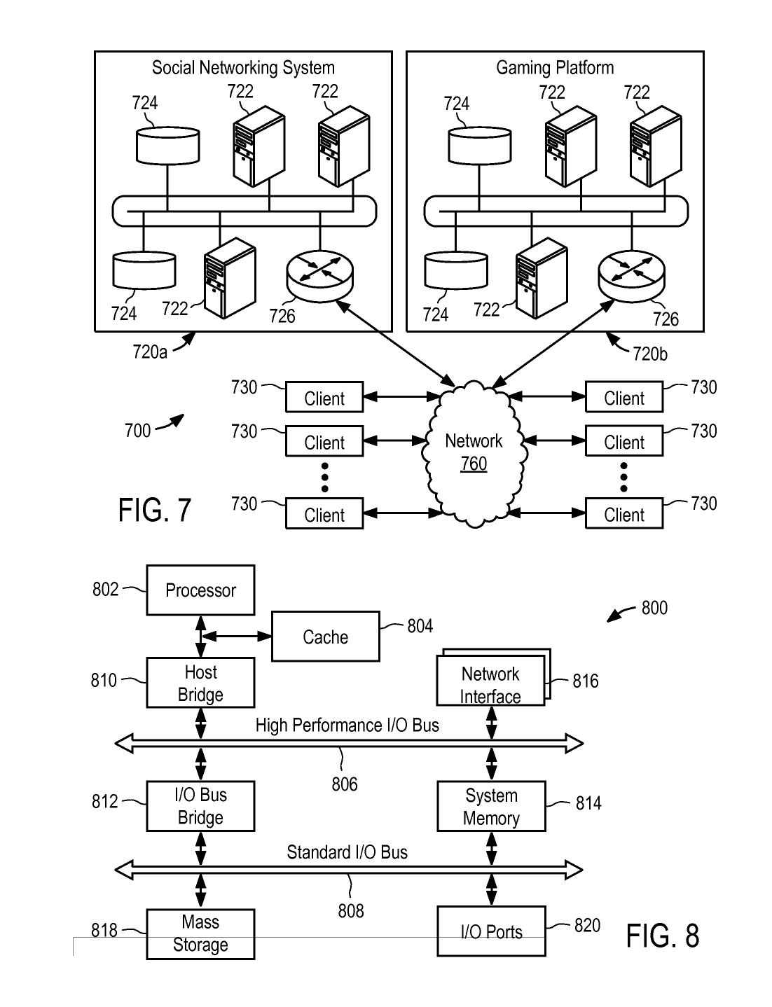

FIG. 8 illustrates an example computing system architecture, which may be used to implement a server 822 or a client system 830. In one embodiment, the hardware system 800 comprises a processor 802, a cache memory 804, and one or more executable modules and drivers, stored on a tangible computer-readable storage medium, directed to the functions described herein. Additionally, the hardware system 800 may include a high performance input/output (I/O) bus 806 and a standard I/O bus 808. A host bridge 810 may couple the processor 802 to the high performance I/O bus 806, whereas the I/O bus bridge 812 couples the two buses 806 and 808 to each other. A system memory 814 and one or more network/communication interfaces 816 may couple to the bus 806. The hardware system 800 may further include video memory (not shown) and a display device coupled to the video memory. Mass storage 818 and I/O ports 820 may couple to the bus 808. The hardware system 800 may optionally include a keyboard, a pointing device, and a display device (not shown) coupled to the bus 808. Collectively, these elements are intended to represent a broad category of computer hardware systems.

The elements of the hardware system 800 are described in greater detail below. In particular, the network interface 816 provides communication between the hardware system 800 and any of a wide range of networks, such as an Ethernet (e.g., IEEE 802.3) network, a backplane, etc. The mass storage 818 provides permanent storage for the data and programming instructions to perform the above-described functions implemented in servers 722 of FIG. 7, whereas system memory 814 (e.g., DRAM) provides temporary storage for the data and programming instructions when executed by the processor 802. I/O ports 820 are one or more serial and/or parallel communication ports that provide communication between additional peripheral devices, which may be coupled to the hardware system 800.

The hardware system 800 may include a variety of system architectures and various components of the hardware system 800 may be rearranged. For example, cache memory 804 may be on-chip with the processor 802. Alternatively, the cache memory 804 and the processor 802 may be packed together as a “processor module,” with processor 802 being referred to as the “processor core.”Furthermore, certain embodiments of the present disclosure may neither require nor include all of the above components. For example, the peripheral devices shown coupled to the standard I/O bus 808 may couple to the high performance I/O bus 806. In addition, in some embodiments, only a single bus may exist, with the components of the hardware system 800 being coupled to the single bus. Furthermore, the hardware system 800 may include additional components, such as additional processors, storage devices, or memories.

An operating system manages and controls the operation of the hardware system 800, including the input and output of data to and from software applications (not shown). The operating system provides an interface between the software applications being executed on the system and the hardware components of the system. Any suitable operating system may be used.

Furthermore, the above-described elements and operations may comprise instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions may be executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

One or more features from any embodiment may be combined with one or more features of any other embodiment without departing from the scope of the disclosure.

A recitation of “a”, “an,” or “the” is intended to mean “one or more” unless specifically indicated to the contrary. In addition, it is to be understood that functional operations, such as “awarding”, “locating”, “permitting” and the like, are executed by game application logic that accesses, and/or causes changes to, various data attribute values maintained in a database or other memory.

The present disclosure encompasses all changes, substitutions, variations, alterations, and modifications to the example embodiments herein that a person having ordinary skill in the art would comprehend. Similarly, where appropriate, the appended claims encompass all changes, substitutions, variations, alterations, and modifications to the example embodiments herein that a person having ordinary skill in the art would comprehend.

For example, the methods, game features and game mechanics described herein may be implemented using hardware components, software components, and/or any combination thereof. By way of example, while embodiments of the present disclosure have been described as operating in connection with a networking website, various embodiments of the present disclosure can be used in connection with any communications facility that supports web applications. Furthermore, in some embodiments the term “web service” and “website” may be used interchangeably and additionally may refer to a custom or generalized API on a device, such as a mobile device (e.g., cellular phone, smart phone, personal GPS, personal digital assistance, personal gaming device, etc.), that makes API calls directly to a server. Still further, while the embodiments described above operate with business-related game objects (such as stores and restaurants), the embodiments can be applied to any in-game asset around which a harvest mechanic is implemented, such as a virtual stove, a plot of land, and the like. The specification and drawings are, accordingly, to be regarded in an illustrative rather than a restrictive sense. It will, however, be evident that various modifications and changes may be made thereunto without departing from the broader spirit and scope of the disclosure as set forth in the claims and that the disclosure is intended to cover all modifications and equivalents within the scope of the following claims.

What is claimed is:

1. A computer-implemented method, comprising:
generating a virtual game environment that includes a first game object and a second game object, the first game object including a location associated with a first location within the virtual game environment, the second game object including a location associated with a second location within the virtual game environment;
responsive to detecting a user selection of the first game object, enabling a move state for the first game object;
responsive to detecting a placement selection that specifies a destination location, updating the location of the first game object from the first location to the destination location, and disabling the move state for the first game object; and
responsive to determining that the destination location specified by the placement selection is proximate to the second location, enabling a move state for the second game object.

2. The computer-implemented method of claim 1, further comprising updating the location of the second game object to a different destination based on detecting another placement selection, the another placement selection specifying the different location.

3. The computer-implemented method of claim 1, wherein the operation of enabling the move state for the second game object and the operation of updating the location of the first game object are performed responsive to the same user input.

4. The computer-implemented method of claim 1, further comprising associating the location of the first game object with a location proximate to a game cursor based on the move state for the first game object being enabled.

5. The computer-implemented method of claim 1, wherein the operation of detecting the placement operation comprises:
detecting a period of time where a game cursor is located over the destination location to the second game object; and
determining that the period of time exceeds a threshold time.

6. The computer-implemented method of claim 1, further comprising determining that the second game object includes a property that indicates that the second game object is a moveable game object.

7. The computer-implemented method of claim 1, wherein the user selection corresponds to at least one of: a keyboard button, a button on a mouse device, a button on a control device, a user interaction with a touch screen display, or a voice command.

8. A computer-implemented system, comprising:
a game engine implemented by one or more processors and configured to generate a virtual game environment that includes a first game object and a second game object, the first game object including a location associated with a first location within the virtual game environment, the second game object including a location associated with a second location within the virtual game environment; and
a control module implemented by the one or more processors and configured to:
responsive to detecting a user selection of the first game object, enable a move state for the first game object;
responsive to detecting a placement selection that specifies a destination location, update the location of the first game object from the first location to the destination location, and disable the move state for the first game object; and
responsive to determining that the destination location specified by the placement selection is proximate to the second location, enable a move state for the second game object.

9. The computer-implemented system of claim 8, wherein the control module is further configured to update the location of the second game object to a different destination based on detecting another placement selection, the another placement selection specifying the different location.

10. The computer-implemented system of claim 8, wherein the control module is configured to enable the move state for the second game object and update the location of the first game object responsive to the same user input.

11. The computer-implemented system of claim 8, wherein the control module is further configured to associate the location of the first game object with a location proximate to a game cursor based on the move state for the first game object being enabled.

12. The computer-implemented system of claim 8, wherein the control module is configured to detect the placement operation based on:
detecting a period of time where a game cursor is located over the destination location to the second game object; and
determining that the period of time exceeds a threshold time.

13. The computer-implemented system of system 8, wherein the control module is further configured to determine that the second game object includes a property that indicates that the second game object is a moveable game object.

14. The computer-implemented system of system 8, wherein the user selection corresponds to at least one of: a keyboard button, a button on a mouse device, a button on a control device, a user interaction with a touch screen display, or a voice command.

15. A non-transitory computer-readable medium storing executable instructions thereon, which, when executed by a processor, cause the processor to perform operations comprising:
generating a virtual game environment that includes a first game object and a second game object, the first game object including a location associated with a first location within the virtual game environment, the second game object including a location associated with a second location within the virtual game environment;
responsive to detecting a user selection of the first game object, enabling a move state for a first game object;
responsive to detecting a placement selection that specifies a destination location, updating the location of the first game object from the first location to the destination location, and disabling the move state for the first game object; and
responsive to determining that the destination location specified by the placement selection is proximate to the second location, enabling a move state for the second game object.

16. The computer-readable medium of claim 15, further comprising updating the location of the second game object to a different destination based on detecting another placement selection, the another placement selection specifying the different location.

17. The computer-readable medium of claim 15, wherein the operation of enabling the move state for the second game object and the operation of updating the location of the first game object are performed responsive to the same user input.

18. The computer-readable medium of claim 15, further comprising associating the location of the first game object with a location proximate to a game cursor based on the move state for the first game object being enabled.

19. The computer-readable medium of claim 15, wherein the operation of detecting the placement operation comprises:
detecting a period of time where a game cursor is located over the destination location to the second game object; and
determining that the period of time exceeds a threshold time.

20. The computer-readable medium of system 15, further comprising determining that the second game object includes a property that indicates that the second game object is a moveable game object.
